(19) United States
(12) Patent Application Publication
(10) Pub. No.: US 2007/0230342 A1
(43) Pub. Date: Oct. 4, 2007

(54) Methods and Devices for Supplying Quality of Service Parameters in Http Messages

(76) Inventor: Robert Skog, Hassleby (SE)

Correspondence Address: ERICSSON INC., 6300 LEGACY DRIVE, M/S EVR 1-C-11, PLANO, TX, 75024, US

(21) Appl. No.: 11/571,636

(22) PCT Filed: Jul. 5, 2004
(86) PCT No.: PCT/SE04/01103

§ 371 Date: Jan. 4, 2007

(51) Int. Cl. H04L 12/56

(52) U.S. Cl. 370/232

(57) ABSTRACT

The present invention relates to changing of Quality of Service parameters to adapt a transmission to varying transmission capacity demands. According to the method of the present invention a message from a second network node 320 is received by a first network node 310 as a response of the content request from a client terminal 105. The message should contain the requested content and information on required quality of service parameters for delivering the content to the client terminal. The information on required quality of service parameters is read by the first network node 310 to determine second quality of service parameters, whereby facilitating an update of quality of service parameters to the second quality of service parameters.

### CROSS-REFERENCE TO RELATED APPLICATIONS

This application is related to commonly assigned co-pending international patent application No. PCT/SE04/______, entitled “Binding Mechanism for Quality of Service Management in a Communication Network”, filed on Jul. 5, 2004; international patent application No. PCT/SE04/______, entitled “Methods and Devices for Changing Quality of Service”, filed on Jul. 5, 2004; and international patent application No. PCT/SE04/______, entitled “Devices and Methods for Push Message Initiated Service”, filed on Jul. 5, 2004, the disclosures of which are incorporated herein by reference.

### FIELD OF THE INVENTION

The present invention relates to methods and devices in mobile communication systems offering packet data service. In particular the invention relates to an end user utilizing services offered by an service provider, via an client terminal, and to the use of Quality of Service classes to adapted a transmission to an expected grade of service.

### BACKGROUND

Modern mobile communication systems providing packet switched services, such as Universal Mobile Telecommunication System (UMTS) should be capable of supporting a large and diverse variety of applications having different demands on needed transmission capacity, sensitivity to delays in the transmission and demands on interactivity, for example. The applications range from a simple transfer of a text message, which is an example of an application that does not require high capacity nor is time critical, to video conferencing, which is a real time application requiring high transmission capacity. The concept of Quality of Service (QoS) was introduced to ensure that an end user, running an application, receives the system resources required for that particular application. At the same time, by not using more recourses than necessary for the application, the use of QoS contributes to the optimization of the use of the system resources, in particular the scarce radio resources. How QoS is implemented in UMTS is described in the technical specifications 3GPP TS 23.107 V6.1.0 (2004-03) and 3GPP TS 23.207 V6.2.0 (2004-03).

Illustrated in FIG. 1 is a generic mobile communication system wherein QoS may be utilized. The mobile communication system 100 comprises a client terminal 105 which may communicate with a network node, for example an application server 120, to use service provided by a service provider, for example. The client terminal 105 should be seen as a representation of various equipment, including, but is not limited to, mobile (cellular) phones, laptop computers and PDAs with communication abilities, and is also commonly referred to as User Equipment (UE) or Mobile Station (MS). A radio access network (RAN) 125, a core network (CN) 130 and a service network (SN) 135 are involved and interacting in providing the communication between the client terminal 105 and the application server 120.

In UMTS QoS is defined with a set of attributes that specifies the UMTS bearer service. The UMTS QoS attributes are the following:
Traffic class
Maximum bit-rate
Guaranteed bit-rate
Delivery order
Maximum SDU size
SDU format information
SDU error ratio
Residual bit error ration
Delivery of erroneous SDUs
Transfer delay
Traffic handling priority
Allocation/Retention Priority
Source statistics descriptor
Signalling Indication

These attributes can be mapped to the pre-defined UMTS QoS classes: Conversational class, Streaming class, Interactive class and Background class. The QoS classes are specified to the communication system by the Packet Data Protocol (PDP) context.

FIG. 2 illustrates schematically communication between a client terminal 105 and the application server 120 in UMTS. The communication occurs via the RNC (Radio Network Controller) 205 and the main nodes SGSN (Serving GPRS support node) 210 and GGSN (Gateway GPRS support node) 215 of the CN 130, to the application server 120 in the SN 135.

In the prior art UMTS implementations the QoS classes are negotiated and managed by using PDP context management. Application level QoS requirements are mapped to PDP context parameters in the client terminal. Pre-configurations of PDP contexts are made in the client terminal such that when a packet switched application starts and connects to the network a matching pre-configured PDP context is activated. This PDP context has a selected QoS class that should match the desired QoS requirements of the application. If for instance the application is a WAP or HTTP browser, the QoS class of the activated PDP context is usually the Interactive class, which is a type of “best effort”. Illustrated in FIG. 2 with an arrow 220, is the PDP context, defining the required QoS class, originating from the client terminal 115 and received by the GGSN 215.

Today, an application, or service node, for example a WWW server may influence the selection of QoS class performed in the client terminal by the Session Description Protocol (SDP). The W server may want, in order to effectuate a streaming session, for example, to use a another bearer better suited for the download, than the already in use. The WWW server may then issue a SDP document to the client terminal, specifying the desired QoS class. Subsequently, the client terminal will have to initiate the actual change of QoS, before the downloading can be performed.

In short, the selection of QoS class can be seen as a process controlled by an application in the client terminal and typically performed during the establishment of a communication session. The selection of QoS class is typically, in practice, static for the session. However, it is well recognized that a browsing session, for example, may exhibit very varying demands on the amount of information to be transferred to the end user. For example in searching, selecting and downloading media files such as music- or videoclips, the searching and selecting impose very moderate demands on the speed of the transfer, whereas the actual downloading may need a bearer of 128 Kb/s or preferably even higher. To constantly use the QoS class only necessary for the most demanding task in a browser session is a waste of radio resources and have a negative impact on the battery life of especially user equipment, since typically more power is consumed while using the high capacity transfer. Thus, there is a need for devices and methods that better adapt to the fluctuations of the required QoS.

### SUMMARY OF THE INVENTION

An object of the present invention is to provide devices and methods that allow a for a network node, or an application in an network node, in the service network to determine appropriate QoS parameters for a bearer service between the client terminal and the application, and to initiate an update of quality of service.

The above stated object is achieved by means of a method in a network node according to claim 1, a network node according to claim 24 and computer program products according to claims 21 and 22.

The basic idea of the present invention is to provide a method and arrangement in a first network node so that the network node may easily determine required QoS parameters suitable for a certain content. A message from a second network node is received by the first network node as a response of the content request from a client terminal. The message should contain the requested content and information on required quality of service parameters for delivering the content to the client terminal. The information on required quality of service parameters is read by the first network node to determine second quality of service parameters, whereby facilitating an update of quality of service parameters to the second quality of service parameters. The method may further identify a requirement for changing quality of service parameters during an ongoing communication session and initiate a modification of quality of service parameters.

According to a first aspect of the present invention a method in the network node is provided which comprises the steps of:
receiving a content request issued by the client terminal;
forwarding the request to the second network node;
receiving a message from the second network node as a response of the forwarded request, the message comprising the requested content and information on required quality of service parameters for delivering the content to the client terminal;
reading from the message the information on required quality of service parameters, and determining second quality of service parameters based on said information on required quality of service parameters; and
issuing an update from the initial quality of service parameters to the second quality of service parameters.

Whereby a delivery of a response to the content request can be performed with the use of the second quality of service parameters.

According to a second aspect of the method of present invention the message is a dedicated MIME-type.

According to a third aspect of the method of present invention the message comprises at least one content part and at least one header part and wherein the quality of service information is provided in the header part. The message may for example be a HTTP response message and the quality of service information is provided in a header line.

According to a fourth aspect of the method of present invention the information on required quality of service parameters is a representation of a quality of service class, preferably from the group of pre-defined UMTS quality of service classes comprising: conversational class, streaming class, interactive class and background class.

According to a fifth aspect of the method of present invention, the method may further comprise a step of determining if quality of service parameters should be updated, said determining based on a comparison (510) of the initial quality of service parameters with the second quality of service parameters, and wherein the step of issuing only is taken if an update is determined in the determining step.

The network node according to the invention is adapted to provide access to services from a service provider in a communication session wherein a client terminal utilizes services provided via the network node and wherein initial quality of service parameters are used. The network node comprises:
quality of service determining means, adapted to, on a content request issued by the client terminal, determine second quality of service parameters associated to the requested content The quality of service determining means is adapted for communication with interface means for interfacing a second network node. The interface means is adapted to forwarding and receiving messages to and from the second network node, and is adapted to read or decode the messages from the second network node; and
quality of service modification means adapted to issue an update from the initial quality of service parameters to the second quality of service parameters, by the use of an update PDP context message.

Thanks to the invention a network node may identify that a response to a content request would benefit from a change of quality of service parameters during an ongoing communication session. If appropriate the network node initiates and effectuates the change of quality of service parameters.

One advantage afforded by the present invention is that the communication system better adapts to varying needs in bearer capacity, typically occurring in a browsing-downloading scenario, wherein media files are downloaded via the network node to the client terminal.

A further advantage is that thanks to the invention, a more efficient uses of the scarce radio resources is made possible, since unnecessary high quality of service, i.e. high bearer capacity, is avoided at times then not explicitly needed.

Yet a further advantage is that since high bearer capacity is used only then explicitly necessary the power consumption is kept at a minimum. This is of greatest importance in user equipment since the battery life hence is prolonged.

Yet a further advantage of the arrangement of the present invention is that the content and the quality of service parameters suitable for delivering the content is contained within the same message. In that way the number of messages exchanged between the first and second network node can be reduced and a reliable connection between the content and the quality of service parameters is achieved.

Further advantages and features of embodiments of the present invention will become apparent when reading the following detailed description in conjunction with the drawings.

### BRIEF DESCRIPTION OF THE DRAWINGS

FIG. 1 is a schematic illustration of a generic mobile communication system;

FIG. 2 is a schematic illustration of the use of PDP context in a mobile communication system;

FIG. 3a is a schematic illustration of a mobile communication system therein the method and arrangements according to the present invention may by used, and 3b is a schematic illustration of the functional parts implemented as software code means of the network node according to the invention;

FIG. 4 is a signal/message sequence scheme illustrating the method according to the present invention;

FIG. 5a is a flowchart of the method according to the present invention, and 3b a flowchart of one embodiment of the method according to the present invention;

FIG. 6 is a schematic illustration of the MIME-type according to one embodiment of the present invention; and

FIG. 7 is a schematic illustration of the HTTP response header according to one embodiment of the present invention.

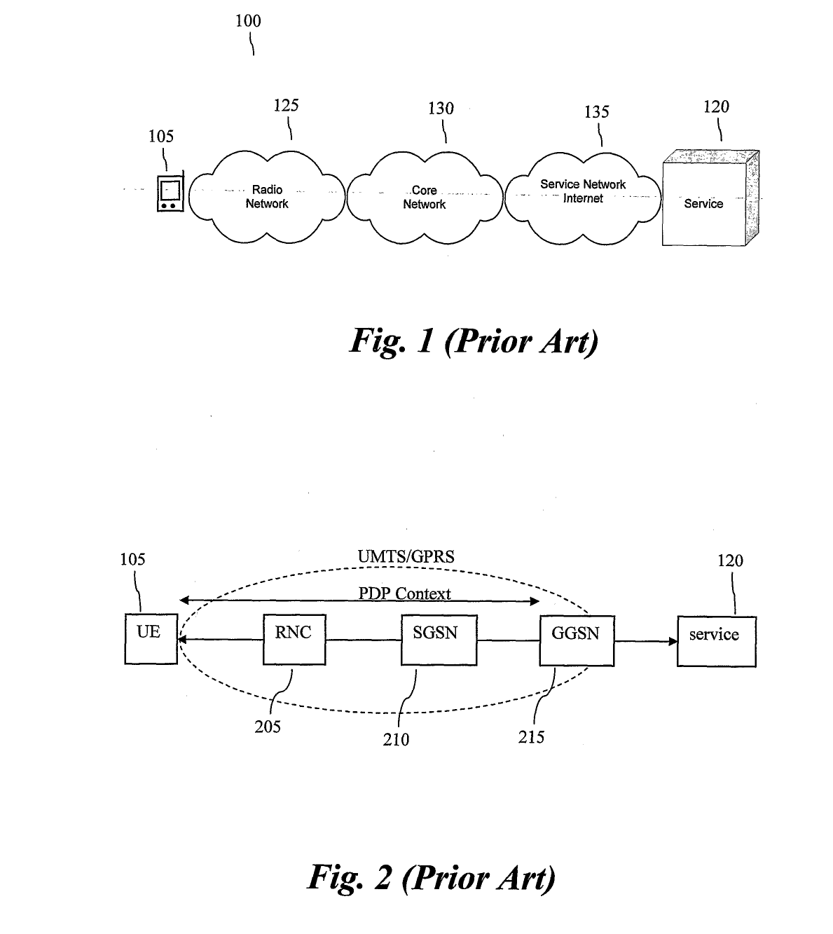

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements.

The present invention is applicable to packet switched services in a mobile communication system, which services typically are provided by a service provider and utilized by an end user with the aid of a client terminal. In particular the present invention relates, but is not limited, to scenarios wherein the end user is browsing web-pages or the like to find and download content such as music, pictures and movie clips, which hereinafter will be referred to as media files. A usage that is characterized by very varying demands on the transmission capacity—for the browsing a “best effort” transmission often suffice, while a download of a media file, for example, impose very high demands on the transmission capacity. As described in the background section prior art methods and arrangement fail to accommodate to the rapid changes in demands of transmission capacity during certain applications such as downloading of media files.

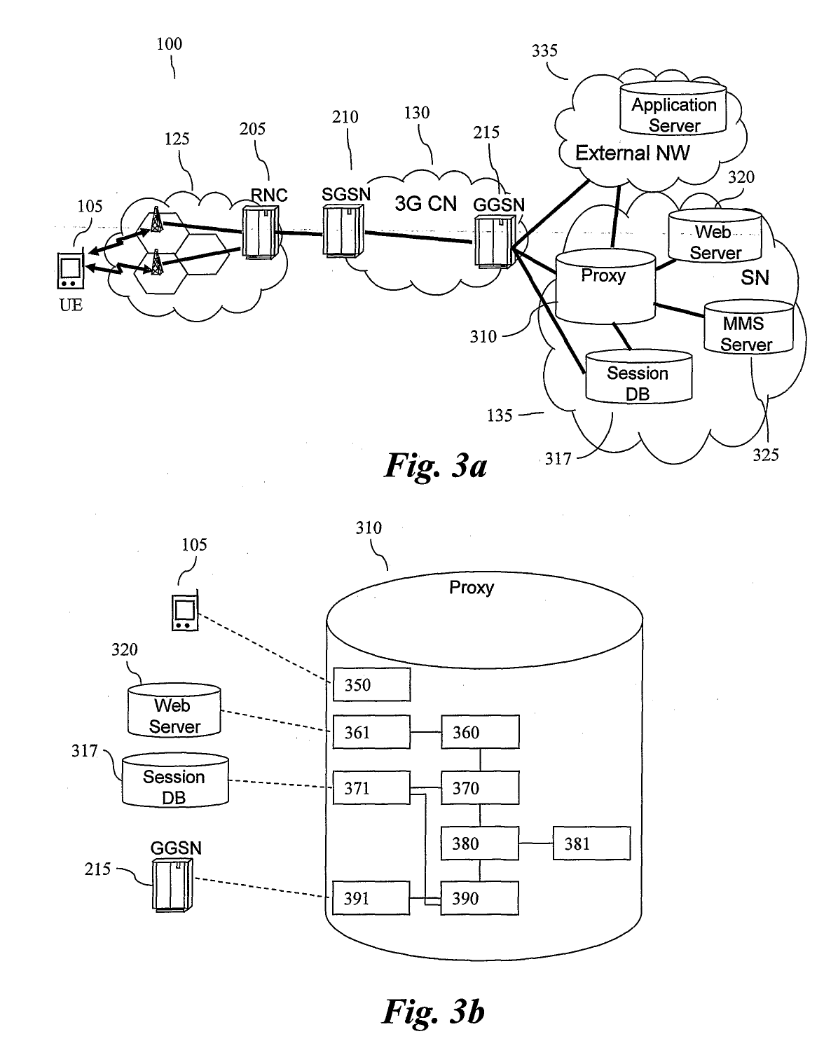

FIG. 3 is a schematic view of a mobile communication system in which the present invention may be used. The mobile communication system 100 comprises a client terminal 105 which may communicate with a network node 310 of a service provider and thereby receive a service that is offered by the service provider. The network node 310 is typically a proxy for the client terminal 105 in the utilization of a WWW-server 320. The communication between the client terminal 105 and the network node 310, typically involves three separate but interconnected networks, the radio access network (RAN) 125, the core network (CN) 130 and the service network (SN) 135. Possible radio access networks 125 includes, but is not limited to, WCDMA, CDMA2000, Wireless LAN or GPRS network. The core and service networks are commonly realized as IP-based or ATM-based communication networks.

The client terminal 105 resides in the radio access network (RAN) 125, which is controlled by at least one Radio Network Controller (RNC) 205 which is in communication with a Serving GPRS support node (SGSN) 210 of the core network 130. The CN 130 are via Gateways nodes in communication with other networks. The Gateway GPRS support node (GGSN) 215 interconnects the CN 130 with the service network 135. The GGSN 215 may further communicate with a session database 317. The network node 310, or proxy, of which the client terminal 105 communicates is part of the service network 135, and may in turn be connected to a further networks node providing the actual service, for example a WWW server 320, an MMS server 325 or application other types of application servers. All of which are part of the service network 135. The network node 310, or proxy, may also be in connection to servers which are not part of the service network 135, but belongs to external networks 335.

According to the present invention is to provide a method and arrangement is provided in a first network node 310 so that the network node may easily determine required QoS parameters suitable for a certain content. A message from a second network node 320, 325 is received by the first network node 310 as a response of the content request from the client terminal 105. The message should contain the requested content and information on required quality of service parameters for delivering the content to the client terminal. The information on required quality of service parameters is read by the first network node 310 to determine second quality of service parameters, whereby facilitating an update of quality of service parameters to the second quality of service parameters. The method may further identify a requirement for changing quality of service parameters during an ongoing communication session and initiate a modification of quality of service parameters. The process is preferably initiated by and controlled by an application in the network node 310.

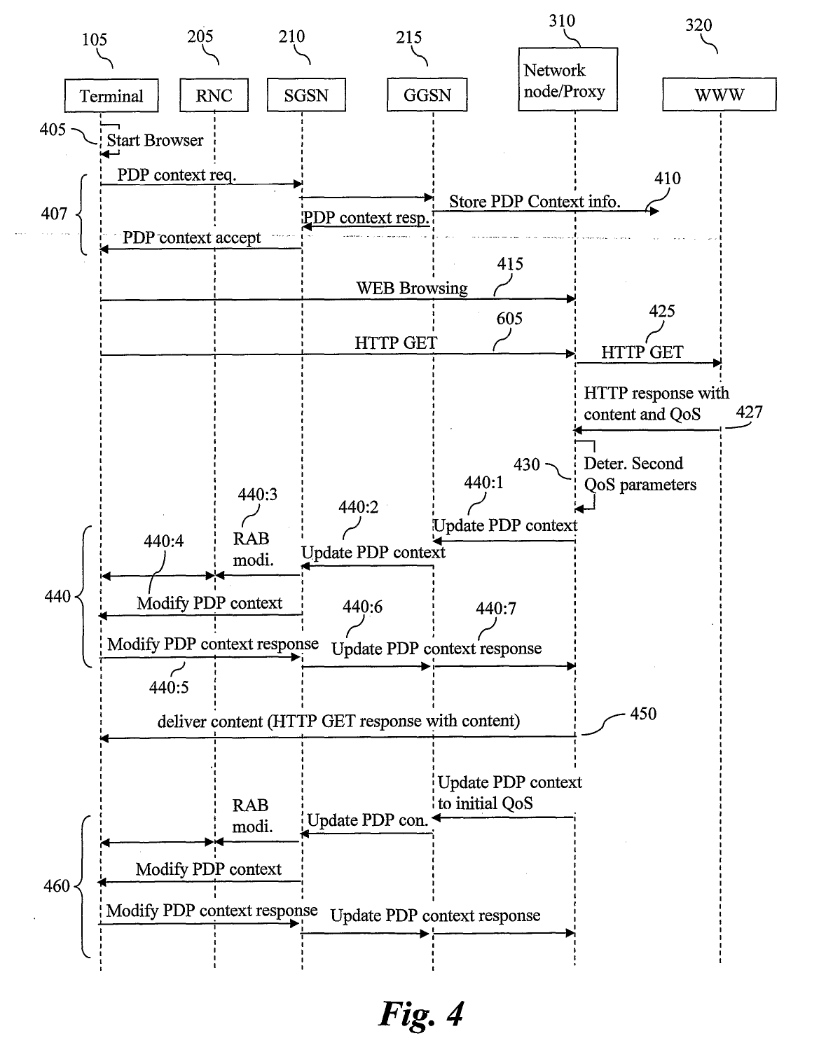

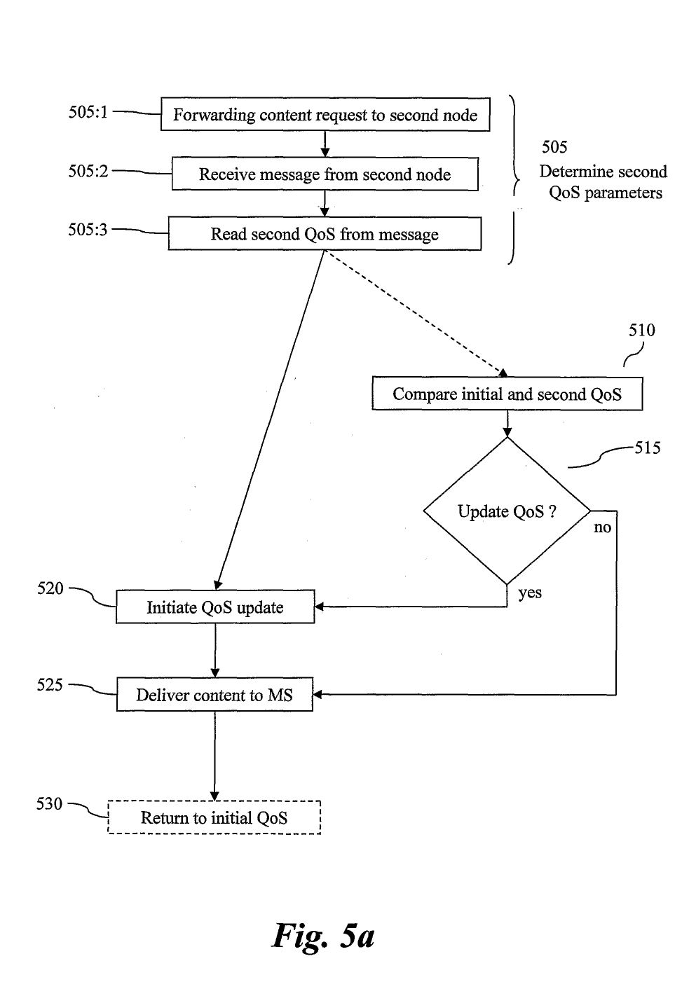

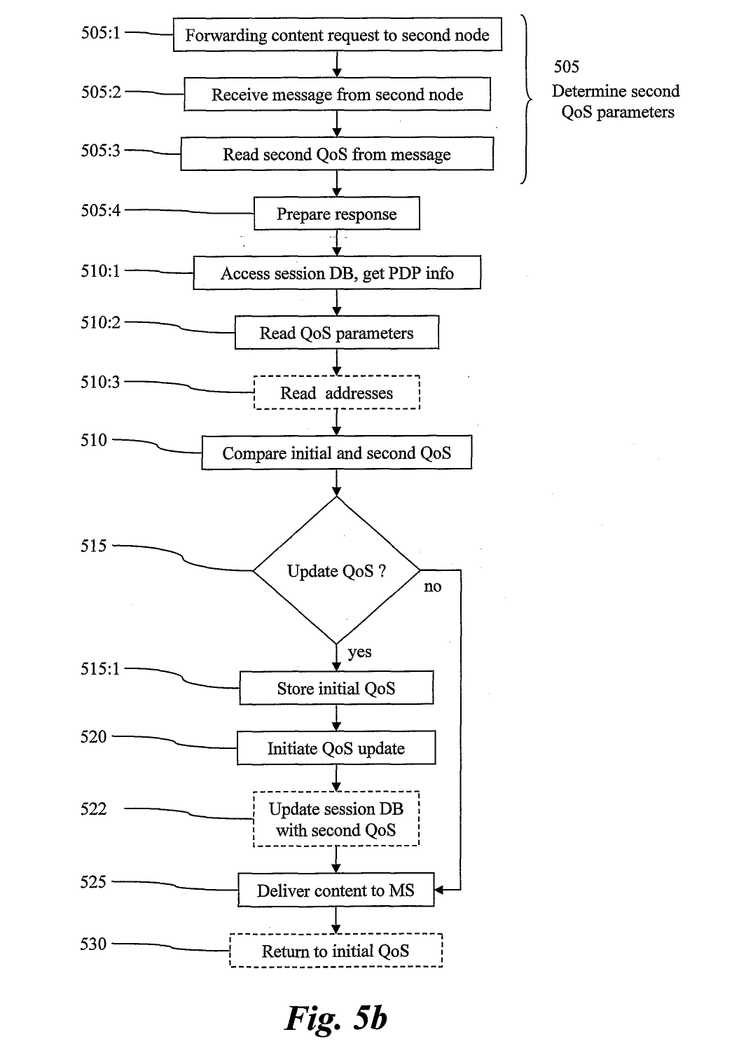

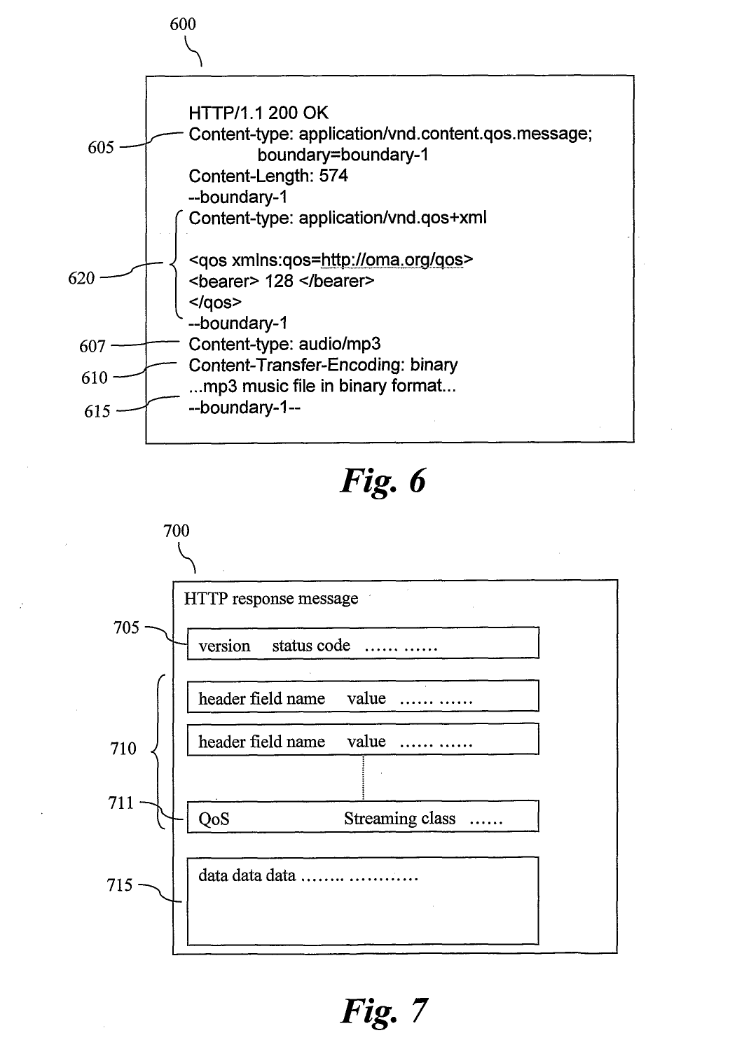

The method and arrangement according to the invention will be described in an UMTS network and with reference to the schematic signalling scheme depicted in FIG. 4 and the flowchart of FIGS. 5a and 5b. Embodiments of the present invention are illustrated in FIG. 6 and FIG. 7.

The method according to the present invention is applicable during a communication session between the client terminal 105 and the network node 310, as illustrated by the signalling scheme of FIG. 4. On an application layer the communication is between an terminal application, for example a browser 405, and the application of the service provider 410, via the proxy application 415 in the network node 310. The communication session has been set up according to the standard procedures which are known in the art. Only the steps of the set up procedure necessary for the understanding of the inventive method will therefore be described. The steps of setting up the communication session should not be regarded as part of the invention.

A communication session typically begins with an end user initiating a packet service application in the client terminal 105, by starting a WEB browser 405, for example. In UMTS PDP context management is used to set up the session with appropriate QoS class, among other parameters. Upon starting an application in the client terminal 105 the application level QoS requirements are mapped to PDP context parameters in the client terminal, typically by activation of a pre-configured PDP context specifying a QoS class which should match the applications QoS requirements. A negotiation process involving the SGSN 210 and the GGSN 215, establish initial QoS parameters to be used in the communication session, as illustrated in the set up part 407 of FIG. 4. The GGSN 215 stores PDP context information in the session data base, indicated by arrow 410. After completion of the set up the communication session proceeds with the establishment of the application level communication, arrow 415, in the current example a WEB browsing session, between the application (browser) in the client terminal 105 and the proxy application of the network node 310.

During the web browsing a content request is issued from the application of the client terminal 105, for example a request of downloading a media file from the WWW server, arrow 420. One example of a content request is a “HTTP GET” message issued to the proxy application 415 of the network node 310. The proxy forwards the request to the WWW server, arrow 425. The WWW server prepares a message comprising both the content and information on the required QoS parameters for effective deliverance of the content, and issues the message as a HTTP response to the proxy, arrow 427. The proxy receives the message, reads and analyze the QoS parameters, and possibly prepares a content delivery according to the above described. The association of QoS parameters to the content will be further discussed below.

The network node 310 initiates a process for modifying 440 the QoS parameters used in the session by issuing an update of PDP context, to the GGSN 215. The network node 310 needs to have information on which GGSN 215 to address, and preferably also include information which the GGSN 215 may use to identify the client terminal 105. Preferably, the network node 310 retrieves this information from the session database 317, which will be further discussed below. The further PDP updating process, arrows 440:2, 3, 4, 5, 6, involves the GGSN 215, SGSN 210, RNC 205 and the Client terminal 105 is performed according to the standard, and hence is well known for the skilled in the art. The GGSN 215 forwards the PDP context response issued by the client terminal 105 to inform the network node 100 of the result of the updating process, arrows 440:7.

The result of the updating process is either that the communication is now occurring according to the requested QoS defined by the second QoS parameters, or that it was not possible to comply to the requested update, for example due to temporary constrains in the radio environment. In the latter case the updating process may result in a QoS that is lower than the requested (second QoS parameters), but possibly higher than the initial QoS parameters. The network node 310 will then have to decide if the content should be delivered with the available QoS or if the process should be abandoned. In most cases a media file will be practically impossible to transfer, or at last highly inconvenient, below a certain transfer right. Accordingly, the network node 310 should in most cases choose to abandon the delivery process if the suitable QoS can not be used. Information on if lower QoS than the requested could still be used for the content (file type) in question, may be included in the second QoS parameters or communicated to the network node 310 by other means.

Upon completion of the Update PDP context, the network node 310 delivers the requested content to the client terminal 105, arrow 450, wherein the second QoS parameters are used.

Alternatively the network node 310 determines if a modification of the QoS parameters used in the session would benefit the delivery of the content to the client terminal 105 by comparing the initial QoS parameters with the second QoS parameters 430. The network node 310 preferably retrieves information on the initial QoS parameters from the PDP context information stored in the session database 317.

If the network node 310 has determined a change to the temporary QoS parameters, e.g. if the initial QoS parameters corresponds to a lower QoS class than the second QoS parameters the modification process is initiated according to the above described. If not, the QoS do not need to be updated in order for the network node 310 to effectively respond to the request.

The application of the network node 310 may further check if the requested QoS comply with the capabilities of the client terminal 105 and with the restrictions of the end user's subscription. A process often referred to as policy check, and which is known in the art. An improved policy check, that may be advantageously utilized in this invention is taught in the above referred application “Binding Mechanism for Quality of Service Management in a Communication Network”.

The network node 310 may after completion of the delivery of the media file, for example, initiate a return to the initial QoS parameters 460. This is performed by an Update PDP context, identical to the Update PDP context described above.

The process of changing QoS during the communication session is according to the method of the invention initiated and controlled from the network node 310. The method in the network node 310 is illustrated in the flowchart of FIG. 5a and comprises the steps of:

505: Determining, on an content request issued by the client terminal 105, second QoS parameters, or a representation of second QoS parameters, associated to the requested content by:
505:1 Forwarding the content request to a second network node, for example a service provider server.
505:2 Receiving a message from the second network node as a response of the forwarded content request of step 505:1. Contained within the message is the requested content and information on required QoS parameters for delivering the content to the client terminal 105.
505:3 Reading from the message the information on required QoS parameters and determining second QoS parameters based on said information on required quality of service parameters. The required QoS parameters may be in a format directly usable as the second QoS parameters, a specification of a QoS class or a alphanumeric representation which the application of the network node 310 may convert to second QoS parameters.

520: Initiate a modification of quality of service parameters by issuing an update from the initial quality of service parameters to the second quality of service parameters.

525: Delivering the requested content to the client terminal 105 with the use of the second QoS parameters.

In many cases it would be favourable to check if the modification of quality of service parameters is necessary, for example to check if the used initial QoS parameters are the same as the second. An alternative embodiment of the method according to the invention comprises the additional steps, to be taken prior to the issuing step (520), of:

510: Comparing the initial QoS parameters with the second QoS parameters.

515: Determining if the QoS parameters should be updated, based on the comparison in step 510. If the second QoS parameters indicate a QoS that is higher, i.e. requires higher bearer capacity, than the QoS in use (the initial QoS parameters) a requirement for updating QoS parameters is identified, for effectuating the content delivery. If not, the content delivery may be performed with the initial QoS parameters, i.e. the QoS parameters do not need to be updated, and hence, the issuing step (520) is not to be taken.

The method may in addition comprise the optional steps of:

523: Preparing the response to the client terminal by removing the information on the QoS parameters from the message.

As discussed above the message (HTTP response) should contain both the content and QoS parameters, or a representation of QoS parameters, required for the delivery of the response. The message should preferably be of a type that can be widely used and interpreted. A suitable format for the combined content and QoS information may be based on Multipurpose Internet Mail Extensions (MIME). MIME refers to an official Internet standard that specifies how messages must be formatted so that they can be exchanged between different systems and has become widely used in for example downloading content via browsers. MIME is a very flexible format, permitting one to include virtually any type of file or document in an email message. Specifically, MIME messages can contain text, images, audio, video, or other application-specific data. A description of MIME can be found in the IETF (Internet Engineering Task Force) publication RFC 1521, 1522.

According to the present invention, in order to meet the demands on flexibility in the use of QoS parameters arising from the varying requirements during a browsing session, a new MIME-type is introduced. The new MIME-type is illustrated in FIG. 6. The MIME-type comprises, among other fields, a main header 605, content-type 607, transfer encoding 610 and content 615, which also is present in the prior art MIME. In the MIME-type according to the invention a new field is introduced, the QoS field 620, specifying the required or desired QoS needed to efficiently transfer the MIME message. The QoS field is preferably, but not necessarily a subfield to the field “content type”. The use of the new MIME-type offers an effective way of exchanging the content and the QoS information. One prerequisite is that the application of the network node 310 needs to have knowledge about this particular MIME-type in order to correctly use the QoS information and to prepare a message which is understandable for the client terminal 105.

As an alternative to using the modified MIME, the information on QoS can be contained in a HTTP header, which represents an alternative embodiment of the invention. In this embodiment, the second network node, e.g. the WWW server, prepares a regular HTTP response, schematically illustrated in FIG. 7, which typically includes a status line 705 indicating version, status code etc, a plurality of header lines 710 which could specify content type and content length, and an entity body 715 comprising the actual data. According to the embodiment of the invention also QoS information is included in the header, preferably as a QoS line 711 among the other header lines specifying content type, size etc. This message format is very versatile. If, for example, the QoS information provided in the header line 711, is not understandable to the proxy application of the network node 310, this information will simply be discarded and the HTTP response delivered anyway. However, probably not with the optimum QoS parameters.

In several steps of the method described with reference to FIG. 5, information on the ongoing communication is needed. Such information is advantageously retrieved from the session database 317. The step 510 of comparing the initial QoS parameters with the second QoS parameters, may comprise the substeps of:

510:1 Accessing the session database 317 to retrieve the PDP information associated with the communication session.

510:2 Reading from the PDP information the initial QoS parameters. The QoS are preferably stored as “Negotiated QoS” defined in the 3GPP TS 24.008.

510:3 Optionally reading addressing information from the PDP information.

The step 515 of determining if the QoS parameters should be updated may comprise the substeps of:

515:1 Storing temporarily the initial QoS parameters to be used in the optional returning to the initial QoS parameters.

The method may in addition comprise the optional steps of:

522: Optionally accessing the session database 317 to update the PDP information with the second QoS parameters. The step to be taken after the modifying step 520 and prior to the delivering step 525.

530: Returning to the use of the initial QoS parameters by issuing an update from the second QoS parameters to the initial QoS parameters similar to step 520. The step to be taken after the delivering step 525.

The information optionally read by the network node 310 in step 510:3 may primarily be used for the application to find end-users GGSN 215 and for the GGSN 215 to map the request to the right GTP (GPRS Tunnel Protocol), i.e. to find the GTP associated with the client terminal 105. Table 1 specifies information concerning addressing that is contained (among other information) in the PDP information of the session database 317 related to the ongoing communication session.

TABLE 1
Attributes in the Session database

| NAS IP Address | The IP address of |
|---|---|
| | the RADIUS client |
| | that sent the |
| | request. This is |
| | usually the IAS or |
| | GGSN. |
| IP Address | The IP address that |
| | is allocated to the |
| | terminal. |
| Calling Station | The MSISDN of the |
| Id | connected terminal |
| (MSISDN) | |
| IMSI | The International |
| | Mobile Subscriber |
| | Identity |
| Negotiated QoS | The negotiated |
| | quality of service as |
| | defined in 3GPP TS |
| | 24.008 |

The NAS IP address can be used by the application of the network node 310 to send the “Update-PDP-request” to the right GGSN 215. IMSI (or MSISDN) can preferably be included in the message from the network node 310 for the GGSN 215 to find the right GTP. Alternatively the session database is updated with a GTP identifier, which directly identifies the GTP of the ongoing communication session.

A most preferred embodiment, comprising a plurality of the presented substeps and options is illustrated in the flowchart according to FIG. 5b, comprises the steps of:

505: Determining, on an content request issued by the client terminal 105, second QoS parameters, or a representation of second QoS parameters, associated to the requested content by:
505:1 Forwarding the content request to a second network node, for example a service provider server.
505:2 Receiving a message from the second network node as a response of the forwarded content request of step 505:1. Contained within the message is the requested content and information on required QoS parameters for delivering the content to the client terminal 105.
505:3 Reading from the message the information on required QoS parameters and determining second QoS parameters based on said information on required quality of service parameters. The required QoS parameters may be in a format directly usable as the second QoS parameters, a specification of a QoS class or a alphanumeric representation which the application of the network node 310 may convert to second QoS parameters.
505:4 Preparing the response to the client terminal by removing the information on the QoS parameters from the message.

510: Comparing the initial QoS parameters with the second QoS parameters by:
510:1 Accessing the session database 317 to retrieve the PDP information associated with the communication session.
510:2 Reading from the PDP information the initial QoS parameters. The QoS are preferably stored as “Negotiated QoS” defined in the 3GPP TS 24.008.
510:3 Reading addressing information from the PDP information.

515: Determining if the QoS parameters should be updated, based on the comparison in step 510. If the second QoS parameters indicate a QoS that is higher, i.e. requires higher bearer capacity, than the QoS in use (the initial QoS parameters) a requirement for updating QoS parameters is identified, for effectuating the content delivery. If not, the content delivery may be performed with the initial QoS parameters, i.e. the QoS parameters do not need to be updated. Storing temporarily (substep 515:1) the initial QoS parameters to be used in the optional returning to the initial QoS parameters.

520: Initiate a modification, if a requirement of modification is identified in the determining step, of quality of service parameters by issuing an update from the initial quality of service parameters to the second quality of service parameters.

522: Accessing the session database 317 to update the PDP information with the second QoS parameters.

525: Delivering the requested content to the client terminal 105 with the use of the second QoS parameters.

530: Returning to the use of the initial QoS parameters by issuing an update from the second QoS parameters to the initial QoS parameters similar to step 520.

The term “second QoS parameters” should be interpreted in a broad sense. i.e. not restricted to parameters explicitly specifying a bit rate, for example. The second QoS parameters may, for example, be a representation of the pre-defined UMTS QoS classes or a representation of an acceptable bit rate range. The representations being decodable by the proxy application of the network node.

In a further embodiment of the present invention the second QoS parameters comprises at least two representations of different QoS levels or classes. A first representation, the desired QoS level, specifying a level (bit rate, for example) to which the content is adapted, and a second representation, the minimum QoS level, specifying the lowest QoS level with which the delivery can still be performed. The application of the network nod may then, upon a negative response to the desired QoS level, either from the policy check or in the Update PDP context response, chose the minimum QoS level, or a level in-between, for the delivery of the content.

The network node 310 according to the present invention comprises a plurality of functional parts, preferably implemented as software code means, to be adapted to effectuate the method according to the invention. In FIG. 3b are the main functional parts, which are involved in an change of QoS during a communication session, schematically depicted. The terms “comprising” and “connected” should here be interpreted as links between functional parts and not necessarily physical connections.

The network node comprises communication means 350 for communicating on an application level with a client terminal 105 and QoS determining means 360, adapted to, on an content request issued by the client terminal 105, determine second QoS parameters associated to the requested content. The QoS determining means 360 preferably comprises, or is connected to interface means 361 for interfacing a second network node which is adapted to forwarding and receiving messages to and from the second network node, and adapted to read or decode the messages from the second network node, especially to read QoS information contained in the messages.

The comparing means 370 of the network node 310 is adapted to compare the initial QoS parameters with the second QoS parameters and is therefore preferably connected to a session database interface 371 for accessing the session database 317 to retrieve the PDP information associated with the communication session and is adapted to read the initial QoS parameters and possibly also addressing information from the PDP information.

The updating determining means 380 is adapted to determine if the QoS parameters should be updated, based on the comparison provided by the comparing means 370. The updating determining means 380 identifies requirement for updating QoS parameters if the second QoS parameters indicate a QoS that is higher, i.e. requires higher bearer capacity, than the QoS in use (the initial QoS parameters). The updating determining means 380 may comprise, or be connected to storing means 381 for storing the initial QoS parameters.

The QoS modification means 390 is adapted to issue an update from the initial quality of service parameters to the second quality of service parameters, by the use of update PDP context message. The update PDP context message should be directed to the appropriate GGSN 215 and is therefore provided with, or connected to, GGSN interface means 391. The QoS modification means may further be adapted to retrieve addressing information from the PDP information and is therefore connected to the session database interface 371.

1. A method in a first network node in a mobile communication network for changing quality of service parameters during an ongoing communication session between the first network node and at least one client terminal using initial quality of service parameters, wherein the first network node is in communication with a second network node, the method comprising the steps of:
receiving a message from the second network node by the first network node as a response of a content request from the client terminal, said message comprising the requested content and information on required quality of service parameters for delivering the content to the client terminal,
reading the information on required quality of service parameters by the first network node to determine second quality of service parameters, and
facilitating an update of quality of service parameters to the second quality of service parameters.

2. The method according to claim 1, further comprising the steps of:
receiving a content request issued by the client terminal;
forwarding the request to the second network node;
receiving a message from the second network node as a response of the forwarded request, the message comprising the requested content and information on required quality of service parameters for delivering the content to the client terminal;
reading from the message the information on required quality of service parameters, and determining second quality of service parameters based on said information on required quality of service parameters; and
issuing, an update from the initial quality of service parameters to the second quality of service parameters and facilitating a delivery of a response to the content request with the use of the second quality of service parameters.

3. The method according to claim 1, wherein the message is a dedicated MIME-type.

4. The method according to claim 1, wherein the message comprises at least one content part and at least one header part and the quality of service information is provided in the header part.

5. The method according to claim 4, wherein the message is an HTTP response message and the quality of service information is provided in a header line.

6. The method according to claim 3, wherein the information on required quality of service parameters is a representation of a quality of service class.

7. The method according to claim 6, wherein the quality of service class are from a group of pre-defined UMTS quality of service classes comprising:
conversational class, streaming class, interactive class and background class.

8. The method according to claim 1, further comprising, prior to the issuing step the step of:
determining if quality of service parameters should be updated, said determining based on a comparison of the initial quality of service parameters with the second quality of service parameters, wherein the step of issuing is taken only if an update is determined.

9. The method according to claim 8, wherein the step of comparing quality of service parameters comprises
retrieving information on the initial quality of service parameters from a session database.

10. The method according to claim 9, wherein the step of retrieving information comprises the steps of:
accessing the session database to retrieve Packet Data Protocol (PDP) information associated with the communication session; and
reading from the PDP information the initial QoS parameters.

11. The method according to claim 10, wherein the step of retrieving information further comprises a step of:
reading addressing information from the PDP information.

12. The method according to claim 11, wherein the addressing information comprises a NAS IP address which is used by the network node to identify a Gateway GPRS support node (GGSN) which is controlling part of the communication with the mobile client terminal 105.

13. The method according to claim 12, wherein the addressing information comprises IMSI or MSISDN for the client terminal, which IMSI or MSISDN the network node include in a message to the GGSN for identifying GPRS Tunnel Protocol (GTP) associated with the ongoing communication session.

14. The method according to claim 1, wherein in the step of comparing quality of service parameters, a requirement for modifying quality of service parameters is identified if the initial quality of service parameters differ from the second quality of service parameters.

15. The method according to claim 14, wherein in the step of comparing quality of service parameters, a requirement for modifying quality of service parameters is identified if the initial quality of service parameters correspond to a lower transfer rate than the transfer rate corresponding to the second quality of service parameters.

16. The method according to claim 6, wherein the initial quality of service parameters is a representation of a first quality of service class.

17. The method according to claim 16, wherein the first quality of service class is from the group of pre-defined UMTS quality of service classes comprising: conversational class, streaming class, interactive class and background class.

18. The method according to claim 1, further comprising the steps of:
storing the initial quality of service parameters; and
returning to the use of the initial quality of service parameters after completion of the response to the request.

19. The method according to claim 18, further comprising the step of: accessing the session database to update the PDP information with the second QoS parameters.

20. The method according to claim 1, further comprising a step of preparing the response to the client terminal by removing the information on the QoS parameters from the message.

21.-22. (canceled)

23. A network node in a mobile communication network adapted to provide access to services from a service provider in a communication session wherein a client terminal utilizes services provided via the network node and wherein initial quality of service parameters are used, the network node comprising:
quality of service determining means, adapted to, on a content request issued by the client terminal, determine second quality of service parameters associated to the requested content, said quality of service determining means adapted for communication with
interface means for interfacing a second network node, said interface means adapted to forwarding and receiving messages to and from the second network node, and adapted to read or decode the messages from the second network node; and
quality of service modification means adapted to issue an update from the initial quality of service parameters to the second quality of service parameters, by the use of an update PDP context message.

24. The network node according to claim 23, wherein the interface means is adapted to read quality of service information contained within a messages from the second network node.

25. The network node according to claim 23, further comprising comparing means adapted to compare the initial quality of service parameters with the second quality of service parameters.

26. The network node according to claim 25, wherein the comparing means is adapted for communication with a session database interface for accessing a session database to retrieve PDP information associated with the communication session.

27. The network node according to claim 26, wherein the session database interface is adapted to read the initial quality of service parameters from the PDP information.

28. The network node according to claim 26, wherein the session database interface is adapted to read addressing information from the PDP information.

29. The network node according to claim 23, further comprising
updating determining means adapted to determine if quality of service parameters in an ongoing communication session should be updated, based on the comparison provided by the comparing means, said updating determining means being adapted to identify a requirement for updating quality of service parameters if the second quality of service parameters indicate a quality of service different from a quality of service indicated by the initial quality of service parameters.

30. The network node according to claim 29, wherein the updating determining means comprises storing means for storing the initial quality of service parameters.

31. The network node according to claim 23, wherein the quality of service modification means is adapted for communication with a GGSN interface means for providing communication facilities to at least one GGSN.

32. The network node according to claim 26, wherein the quality of service modification means is adapted for communication with the session database interface to retrieve addressing information from the PDP information.
